(19) United States
(12) Patent Application Publication
(10) Pub. No.: US 2012/0158685 A1
(43) Pub. Date: Jun. 21, 2012

(54) Modeling Intent and Ranking Search Results Using Activity-based Context

(75) Inventors: Ryen W. White, Woodinville, WA (US); Paul Nathan Bennett, Kirkland, WA (US); Susan T. Dumais, Kirkland, WA (US); Peter Richard Bailey, Kirkland, WA (US); Fedor Vladimirovich Borisyuk, Nizhny Novgorod (RU); Xiaoyuan Cui, Beijing (CN)

(73) Assignee: MICROSOFT CORPORATION, Redmond, WA (US)

(21) Appl. No.: 12/970,875

(22) Filed: Dec. 16, 2010

(51) Int. Cl. G06F 17/30

(52) U.S. Cl. 707/706; 707/769; 707/723; 707/E17.108

(57) ABSTRACT

The subject disclosure is directed towards building one or more context and query models representative of users' search interests based on their logged interaction behaviors (context) preceding search queries. The models are combined into an intent model by learning an optimal combination (e.g., relative weight) for combining the context model with a query model for a query. The resultant intent model may be used to perform a query-related task, such as to rank or re-rank online search results, predict future interests, select advertisements, and so forth.

### BACKGROUND

As a general rule, search engines are able to return more relevant search results given a more specific query, as opposed to an ambiguous query that can have multiple interpretations. A search query considered in isolation offers limited information about a searcher's intent. For example, if a person simply types in a commonly used word or short phrase, such as “jaguar,” there is no way to know in isolation that the user's intention with respect to that word or short phrase is directed to finding content related to the car, the animal, the football team, or something else. Nevertheless, most search systems match user queries to documents independent of the interests and activities of the searcher beyond the current query.

In an attempt to provide more relevant results, there is more and more research being conducted with respect to using knowledge of a searcher's interests and/or prior search context to improve various aspects of search technology (e.g., ranking, query suggestion, query classification and so forth). User interests can be modeled using different sources of profile information, such as explicit location, demographic or interest profiles, or implicit profiles/context data based on previous queries, search result clicks, general browsing activity, or even richer desktop indices. Such implicit information can be based on long-term patterns of interaction, or on short-term patterns.

Users, advertisers and search engine providers all benefit from providing more relevant search results, including links to more relevant content and advertisements, and more relevant query suggestions, for example. As such, any technology that returns more relevant information is desirable.

### SUMMARY

This Summary is provided to introduce a selection of representative concepts in a simplified form that are further described below in the Detailed Description. This Summary is not intended to identify key features or essential features of the claimed subject matter, nor is it intended to be used in any way that would limit the scope of the claimed subject matter.

Briefly, various aspects of the subject matter described herein are directed towards a technology by which an intent model containing data corresponding to an optimal combination of query information and context information is used to perform a query-related task. In one aspect, upon receiving a search query from a user, context information comprising one or more search-related activities of the user that occurred prior to the search query is obtained. Features of the search query and features of the context information are used to obtain intent data from an intent model. For example, the intent data may correspond to an optimal way to combine the query information with the context information, such as to use in ranking or re-ranking search results. Other uses of the intent data include selecting/ranking/re-ranking advertisements, predicting a task, performing query classification, or performing query suggestion.

In one aspect, user search interests using interaction behavior are modeled into one or more query models and context models based upon a query and its associated context information representing pre-query activity. These models are combined into an intent model, which is then used to perform a query-related task. Learning the intent model may include learning an optimum combination of query and context models based upon future actions (e.g., corresponding to a relevance model) or explicit relevance judgments associated with the query information and the context information.

In one aspect, to build the query and context models, the query is classified based on its corresponding returned search result pages into a query category distribution associated with the query information. The pre-query activity (context) is classified based on one or more pages and/or queries corresponding to that activity into a context category distribution associated with the context information.

Other advantages may become apparent from the following detailed description when taken in conjunction with the drawings.

### BRIEF DESCRIPTION OF THE DRAWINGS

The present invention is illustrated by way of example and not limited in the accompanying figures in which like reference numerals indicate similar elements and in which:

FIG. 1 is a block diagram representing example components for classifying queries and context based on categories for use in developing query and context models.

FIG. 2 is representation of modeling search context, a query and post-click behavior to build an intent model for a search session.

FIG. 3 is a block diagram representing example components for re-ranking search results based upon an intent model to illustrate one example usage scenario for the intent model.

FIG. 4 is a flow diagram representing example steps for building an intent model in an offline process, and (sometime later) using the intent model in an online process to affect search results.

FIG. 5 is a block diagram representing exemplary non-limiting networked environments in which various embodiments described herein can be implemented.

FIG. 6 is a block diagram representing an exemplary non-limiting computing system or operating environment in which one or more aspects of various embodiments described herein can be implemented.

### DETAILED DESCRIPTION

Various aspects of the technology described herein are generally directed towards using query context that considers pre-query activity (e.g., previous queries and page visits) to provide richer information about a user's search intentions. As will be understood, such information may be used to predict future actions for applications such as re-ranking search results, classifying the query, suggesting alternative query formulations, selecting advertisements, task prediction, and so forth.

In one aspect, the technology described herein uses/builds one or more models of users' search interests based on their interaction behavior preceding a search query (or set of queries) and/or any explicit user specifications. As will be understood, the technology described herein may learn an optimal weight (on a per-query basis and/or across all queries), or use an assigned weight, to combine a context model with a model for the current query into a resultant intent model. The intent model may be used in online search processing to rank or re-rank search results, predict future interests, and/or for other related purposes.

It should be understood that any of the examples herein are non-limiting. As such, the present invention is not limited to any particular embodiments, aspects, concepts, structures, functionalities or examples described herein. Rather, any of the embodiments, aspects, concepts, structures, functionalities or examples described herein are non-limiting, and the present invention may be used various ways that provide benefits and advantages in computing and search technology in general.

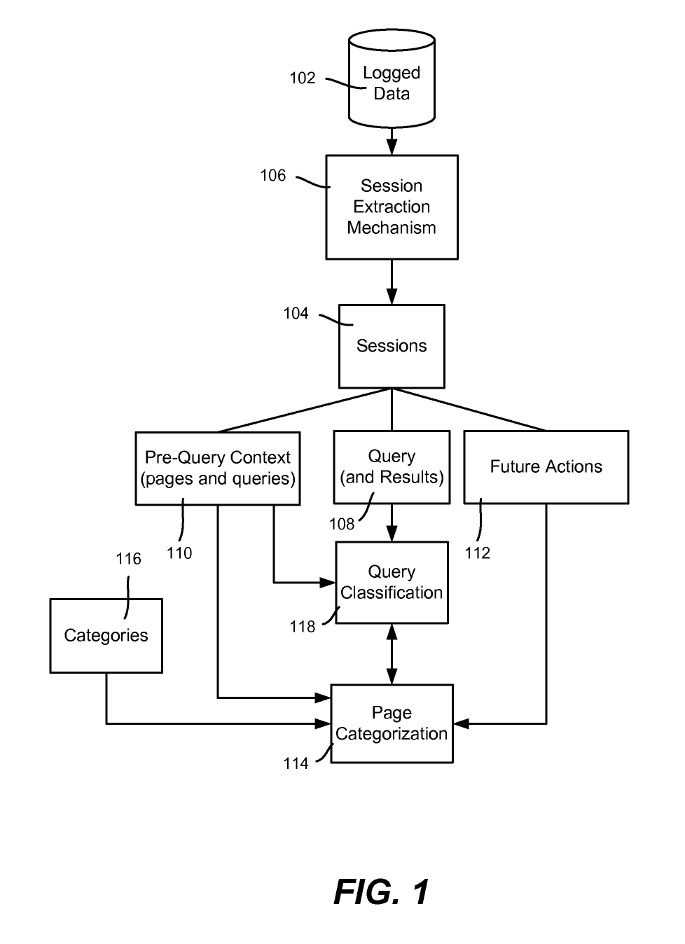

FIG. 1 shows example concepts related to determining a user's intent with respect to a search based on logged data 102. This may be used performing offline or dynamic training of models that represent that intent. The trained models may then be used in online query processing as described below. In general, the logged data 102 comprises one or more search logs and/or browser-based logs, providing searching and browsing episodes from which search-related data, including context, is extracted. Log entries include a timestamp for each page view, and the URL of the web page visited.

From these data search sessions 104 are extracted by a suitable extraction mechanism 106. In one implementation, each search session begins with a query, occurs within the same browser instance and tab instance (to lessen the effect of any multi-tasking that users may perform), and terminates following some time (e.g., thirty minutes) of user inactivity. Note that browser-based logs rather than traditional search-engine logs may be used because they provide access to all pages visited in the search session, including any preceding the search query and any succeeding the search query. Thus, for a selected query 108, there is pre-query context 110 and future actions 112.

Accurate understanding of current interests and prediction of future interests are established tasks for user modeling. For example, a query such as [ACL] may be interpreted differently depending on whether the previous query was [knee injury] vs. [syntactic parsing] vs. [country music]. When used with the technology described herein, a range of possible applications arise from having this contextual knowledge for a query, such as re-ranking search results, classifying the query, selecting relevant advertisements, suggesting alternative query formulations and so forth. Similarly, an accurate understanding of current and future interests may be used to dynamically adapt search interfaces to support different tasks.

With respect to the logged data 102, to augment browser-based logs, traditional search engine logs are mined to obtain the URLs of the top-N (e.g., top-ten) search results returned for each query, to build query models as described below. In addition to query models, context models are also built, as described below.

In one implementation, the query models and context model represent the user interests as a probability distribution across labels from the Open Directory Project (ODP, www.dmoz.org), hereafter referred to as L, although other model representations and sources of labels such as reference sites, queries from search logs, and so forth may also be used. In one implementation, labels are assigned to pages using a combination of text classification based on content or the like, and URL lookup in the ODP taxonomy. This label assignment (e.g., combined text and URL lookup) is represented in FIG. 1 via the page categorization block 114 accessing categories 116 (e.g., the ODP taxonomy).

In one implementation, context is represented as a distribution across categories in the ODP topical hierarchy. This provides a consistent topical representation of queries and page visits from which to build the models. ODP categories 116 may also be effective for reflecting topical differences in the search results for a query or a user's interests. To this end, automatic categorization techniques (block 114) assign an ODP category label to each page; for example, categorization begins with URLs present in the ODP and incrementally prunes non-present URLs until a match is found or miss declared. To lessen the impact of small differences in the labels assigned, filtering or weighting may be performed, such as to only use categories at the top two levels of the ODP hierarchy.

To improve the coverage of the categorization (block 114), it may be combined with a known text-based classifier, (described in Bennett, P., Svore, K. and Dumais, S. (2010); “Classification-enhanced ranking,” Proc. WWW, 111-120), which uses logistic regression to predict the ODP category for a given web page. For URLs where only one classifier had labels, the most frequent label (for ODP lookup) or the most probable label (for the text-based classifier) may be used. For URLs where both classifiers had a label, the label may be determined by looking for an exact match in the ODP, then in the classified index pages, and then incrementally pruning the URL and checking for a category label in the ODP or in the classified index pages.

Thus, in one implementation, three sources were used to build context models from search sessions 104. For the query 108, ODP labels automatically assigned to the top-ten search results for the query returned by the engine may be used. For the second model, SERPClick, ODP labels may be automatically assigned to the search results clicked by the user during a current search session. A third model was NavTrail; corresponding to ODP labels automatically assigned to web pages that the user visits following a SERP (search engine results page) click. Note that models based on a combination of these three sources (e.g., Query+SERPClick+NavTrail) also may be created

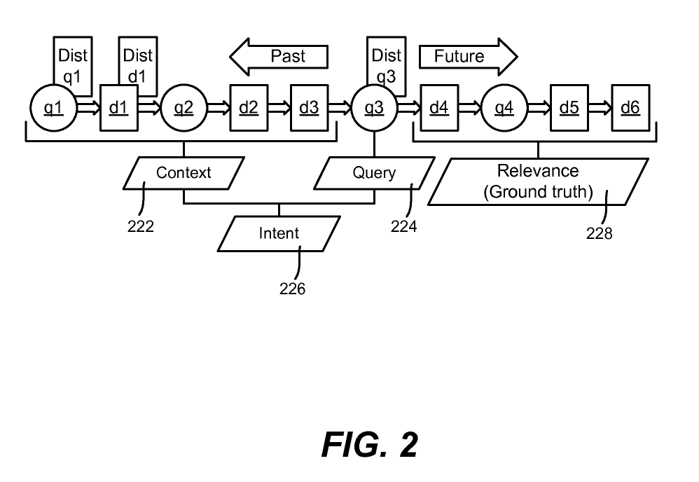

FIG. 2 represents some of the concepts of FIG. 1 with example queries and clicked documents. Past context data (e.g., from queries represented as circles q1 and q2 plus the documents (URLs/pages) d1-d3 clicked represented as rectangles) correspond to a context model 222, which may be combined with the user's current query data (the model 224 corresponding to q3) to compute an intent model 226; (the combination of the query and its context is referred to herein as “intent”). Note that each document and query is labeled with their categories and a probability distribution for each category. In FIG. 2, query q1, document d1, and query q3 are each shown with a box identified as “Dist” to represent this association; other queries and documents each have their own distribution, but these are not shown for purposes of clarity. In general, the pages and queries are represented by these distributions as described herein.

As described below, the context and queries may have different weights when combined into the intent based upon an interest model. Note that context may be based on anything related to a user's actions, including a type of page or previous determinations (the user was on a news-related page). Further, note that “models” are different from “sources”; sources determine the information used in building the models, and for example may include queries issued, result clicks on search engine result pages, and pages visited on the navigation trail following SERP clicks. The decision about which sources are used in constructing the models can be made based on availability (e.g., search engines may only have access to queries and SERP clicks) and/or desired predictive performance (more sources may lead to more accurate models, but may also contain more noise if searchers deviate from a single task).

Using classification/categorization such as described above, the interest models are built from logged data 102, including for each processed query, the current query 108, its context 110 comprising preceding session activity such as previous queries and previous clicks on search results, and logged future actions 112 (documents d4-d6 and query q4 in FIG. 2). Note that in one alternative, instead of (or in addition to) such implicit judgments, explicit user judgments (e.g., where the user marks queries, pages, and so forth as relevant) may also be used in building the models.

Thus, two models are constructed to represent users' short term interests, namely query Q (corresponding to the current query) represented by the model 224, context X (queries and/or items viewed prior to the current query) represented by the model 222; from these, a third model is constructed comprising intent I (a weighted combination of current query and context), represented by the model 226. Previous actions generally include events from within the current search session, but may be extended beyond the start of the session to also consider general browsing events. The future actions 112 comprising the sequence of actions following the current query in the session are used to develop a relevance model 228 used as ground truth, such as for use in tuning the models for use in predictive performance and/or ranking or re-ranking effectiveness. The future interests of the user can be used to evaluate the predictive effectiveness of these models using future actions.

With respect to the query model 224, given the above method for assigning ODP category labels to URLs, labels are assigned to a query as follows. For each query, the category labels for the top-N (e.g., top ten) search results returned by a search engine are obtained. Probabilities are assigned to the categories in L by using information about which URLs are clicked for each query. In one implementation, the normalized click frequencies are obtained for each of the top-N results from search-engine click log data, and used to compute the distribution across all ODP category labels. Search results without click information are ignored in this implementation. ODP categories in L that are not used to label top-ranked results may be assigned prior probabilities determined across a large set of historic queries and/or previous URLs.

The context model 222 is constructed based on actions that occur prior to the current query in the search session. Actions comprise queries, web pages visited through a SERP click, or web pages visited on the navigational trail following a SERP click. For queries within the pre-query context 110, a query model is created using the method described above. For pages within the pre-query context 110, a model for each web page is created using the ODP category label assigned such as via the strategy described above (e.g., first check for an exact match in the ODP, and apply text-based classification as needed).

The weight attributed to the category label assigned to each page may be based on the amount of time that the user dwells on that page, for example. Other weighting schemes (e.g., based on the page quality or popularity for the current query in general across a large number of users) also may be employed. However, instead of using a binary relevant/non-relevant threshold time (e.g., thirty seconds), a sigmoid function may be used to smoothly assign weights to the categories. In one implementation, function values can range from just above zero initially to one at thirty seconds. Note that there are many possible ways to smooth the weights assigned from dwell times or the like.

In addition to varying the probability assigned to the class based on page dwell time, an exponentially-decreasing weight may be assigned to each action as it moves deeper into the context. In other words, pre-query actions may be weighted according to e⁻⁽ⁿ⁻¹⁾, where n represents the number of actions before the current query. Using this function allows for assigning the action immediately preceding the current query one weight (e.g., a weight of one), and down-weighting the importance of preceding session actions, such that more distant events receive lower weights. In this way, page and query models in the context 110 may have their contribution toward the overall context model 222 weighted based on this discount function. Note that other discounting may be used, e.g., the distributions of pages in the context may be weighted more than queries, for example, or vice-versa.

In one implementation, these models are merged and their probabilities normalized so that they sum to one (after priors are assigned to unobserved categories). The resultant distribution over the ODP category labels in L represents the user's context at query time.

In one implementation, the intent model 226 is a weighted linear combination of the query model (for the current query) and the context model (for the previous actions in the search session). Because this model includes information from the current query and from the previous actions, the intent model can potentially provide a more accurate representation of user interests than the query model or the context model alone. One suitable intent model is defined as:

I(w)=wX+(1−w)Q where wε[0,1] (1)

and where I, X, and Q represent the intent, context, and query models respectively, and w represents the weight assigned to the context model. When combining the query and context models to form the intent model, by default w=0.5. However, what comprises the optimal value of w varies per query and can be more accurately predicted using features of the query and its activity-based context, as described below.

The relevance model 228 (“or ground truth”) contains actions that occur following the current query q3 in the session. This captures the “future” as shown in FIG. 2 and represents the ground truth for evaluating predictions. The relevance model 228 comprises a probability distribution over L and is constructed in a similar way to the context model 222, except that the relevance model considers future actions rather than past actions.

In the relevance model 228, the action immediately following the query (typically another query or a SERP click) may be weighted most highly, and with the weight decreased for each succeeding action in the session (e.g., using the same exponential decay function as the context model). This regards the next action as more important to the user than the other actions in the remainder of the session, on the assumption that the subsequent action is likely most closely related to the interests for the search query. Note that this decay is optional, and any reasonable weighting scheme (even “no decay”) may be used. This relevance model 228 may be used for measuring the accuracy of predictions of short-term user interests, and thus for learning the optimal combination of query and context for a query as described below. Because the relevance model 228 is automatically generated, it may be used to evaluate performance on a large and diverse set of queries, but may contain noise associated with variance in search behavior.

To learn the optimal weight to assign to context when combining the context model and the query model, one implementation identifies the optimal context weight (w) for each query on a held out training set, creating features for the query and the context that could be useful in predicting w, and then learning w using those features.

A general goal of the optimization is to determine the context weight that minimizes the difference in distributions between the intent model and the relevance models. To construct a set for learning, the process is provided with a set of queries with their context 222, query 224, and relevance models 228 collected from observed session behavior. The process converts the knowledge of the future represented in the relevance model 228 to an optimal context weight that is then used for training a prediction model. The function to minimize in this example scenario is the cross-entropy between the intent model 226 and the relevance model 228; (note that other measures of the difference (e.g. squared difference) between the intent model and relevance model may be minimized in other implementations). In this example, the reference distribution is the relevance model 228, and the cross-entropy takes its minimal value (the entropy of the relevance distribution) when the intent model distribution is equal to the relevance distribution. A suitable objective function used is:

$${min}_{w} [ - {\sum }_{c} {R}_{c} {log}_{2} [ {I}_{c} ( w ) ] ] + {a ( {log}_{2} \frac{w}{1 - w} )}^{2} \qquad ( 2 )$$

where I_{c}(w)=wX_{c}+(1−w)Q_{c}

such that wε(0,1)

Here R_{c}, X_{c}, and Q_{c} represent the probability assigned to the cth category by relevance, context, and current query models, respectively. Similarly, I_{c}(w) is the corresponding intent probability using was the context weight. The first term in this equation is the cross-entropy between the relevance and intent distributions. The second term is a regularizer that penalizes deviations from w=0.5; it is essentially a Gaussian regularization applied after a logit transform (which is monotone in w and symmetric around w=0.5); note that the regularizer is not necessary, but can be mathematically convenient as described herein. The regularizer also has the negligible effect of constraining the optimum to lie in the open interval (0,1) instead of the closed interval [0,1]. After squaring, the regularization term is convex. Because cross-entropy minimization is also known to be convex, for a>0, the resulting problem is convex and can be minimized efficiently to find an optimal value of w. In addition to keeping w closer to 0.5, the regularizer is helpful in that without it, small deviations in the distributions (e.g., due to floating point imprecision) can force the optimal weight to 0.0 or 1.0, although the value of the objective is essentially (near) flat. This adds a source of unnecessary noise to learning and is thus handled through regularization. In one implementation, a=0.01, however other values for this parameter may be used. Note that it is possible to compute a global optimum across all queries by combining the values in equation (2) across all queries in the training set. However, per-query optimum weights provide benefits such as the ability to dynamically adapt the amount of weight assigned to the context based on the query.

Thus, in one implementation, to create a training set, the query, context, and relevance models are used to compute the optimal context weight per query by minimizing the regularized cross-entropy for each query independently. Note that the relevance model 228 is implicitly the labeled signal which optimization converts to a “gold-standard” weight to be used in learning and prediction.

The following tables sets forth example features that may be used in predicting an optimal context weight; (log-based features for the query are italicized):

| | |
|---|---|
| Feature | Feature description |

Query class

| | |
|---|---|
| QueryLength | Number of characters in query |
| QueryWordLength | Number of words in query |
| AvgQueryWordLength | Average length of query words |
| AvgClickPos | Average SERP click position for query |
| AvgNumClicks | Average number of SERP clicks for query |
| AvgNumAds | Average number of advertisements shown |
| | on the SERP for query |
| AvgNumQuerySuggestions | Average number of query suggestions shown |
| | on the SERP for query |
| AvgNumResults | Average number of total search results |
| | returned for the query |
| AbandonmentRate | Fraction of times query issued and has no |
| | SERP click |
| PaginationRate | Fraction of times query issued and next |
| | page of results requested |
| QueryCount | Number of query occurrences |
| HasDefinitive | True if a single best result for the |
| | query is in the result set (usually for |
| | navigational queries) |
| HasSpellCorrection | True if search engine spelling correction |
| | is offered for query |
| HasAlteration | True if query is automatically modified |
| | by engine (e.g., stemming) |
| FracQueryModelNotPrior | Fraction of all categories in the query |
| | model that are instantiated |
| QueryEntropy | Entropy of the query model |
| ClickEntropy | Click entropy of query based on |
| | distribution of result clicks |
| QueryJensenShannon | Jensen-Shannon divergence between the |
| | query model and the previous query model |
| | in session |

Context class

| | |
|---|---|
| NumActions | Number of queries and page visits |
| | (excludes current query) |
| NumQueries | Number of queries (excludes current |
| | query) |
| Time | Time spent in session so far |
| NumSERPClicks | Number of search results clicked |
| NumPages | Number of non-SERP pages visited |
| NumUniqueDomains | Number of unique domains visited |
| NumBacks | Number of session page revisits |
| NumSATDwells | Number of page dwells exceeding a 30- |
| | second dwell time threshold |
| AvgQueryOverlap | Average percentage query overlap between |
| | all successive queries |
| FracContextModelNotPrior | Fraction of all categories in the context |
| | model that are instantiated |
| LastContextWeight | Previous estimate of optimal context |
| | weight in the session. Note: Uses |
| | previous query model, previous context |
| | model, and actions between previous query |
| | and current query as relevance model |
| | (ground truth) |
| ContextEntropy | Entropy of the context model |
| ContextEntropyByNumAct | Entropy of the context model divided by |
| | the number of actions in session so far |
| ContextJensenShannon | Jensen-Shannon divergence between the |
| | context model and the previous context |
| | model in session |

QueryContext class

| | |
|---|---|
| QueryContextCrossEntropy | Cross entropy between the query model and |
| | the context model |
| ContextQueryCrossEntropy | Cross entropy between the context model |
| | and the query model |
| JensenShannonDivergence | Jensen-Shannon divergence between the |
| | query model and the context model |

In one implementation, well-known Multiple Additive Regression Trees (MART) were used to train a regression model to predict the optimal context weight. MART uses gradient tree boosting methods for regression and classification. Other machine learning algorithms may be used for this purpose, however MART has some strengths with respect to this task, including model interpretability (e.g., a ranked list of important features is generated), facility for rapid training and testing, and robustness against noisy labels and missing values.

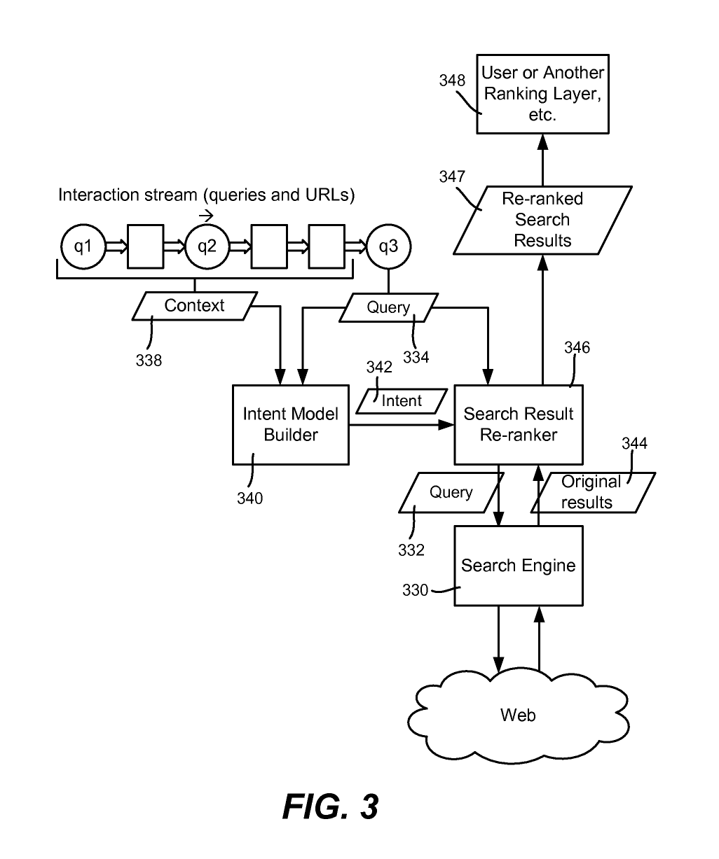

Turning to online usage (that is, at query time) as represented in FIG. 3, in general, a search engine 330 and associated components have access to a large number of features about the query 332 and the activity-based search context, which may be useful for dynamically learning/dynamically predicting the optimal context weight. Note that the query 332 is not necessarily a full user-provided search query, e.g., dynamic links placed on a web page may lead directly to results or are themselves query suggestions on the user's recent action; also, a user may only type part of a query to have one completed for the user. Thus, a “search query” as used herein may be directly typed by a user, but also may correspond to search query-related information. In an implementation that uses the features in the above table, (including log-based features based on search engine logs, italicized in the table), the features may be divided into three classes, namely Query, capturing characteristics of the current query 332 and the query model 334 corresponding to this particular query; Context, capturing aspects of the pre-query interaction behavior as well as features of the current context model or models 338 themselves, and QueryContext, capturing aspects of how the query model and context model compare. An intent model builder 340 may use these features to predict the relative weight of the query and the context when constructing an intent model 342 from recent user activity and the query 332.

More particularly, the intent model builder 340 takes as input the current query and the context comprising previous session actions, and generates an intent model 342 used to re-rank the search results. In general, based on features of the query and/or the relevance of the context to the query, along with the previously learned intent model 226 (FIGS. 1 and 2), the model builder 340 decides how much weight to put on the query and how much to place on the context.

In one alternative, the intent model 342 can be used to re-rank the top original search results 344 obtained from the search engine 330, in order to bring pages more relevant to the user intent to the top of the ranked list of search results. In one implementation the intent model 342 is used by a search result re-ranker 346 to perform the re-ranking. This may be accomplished by first obtaining the top-ranked results 344 from the search engine 330, and then comparing each URL of the search results with the intent model 342, and assigning it a weight based on the degree of match between the ODP categories and probabilities assigned to the URL, and the ODP categories and probabilities assigned to each of the search results. The results may then be re-ranked based on this weight into re-ranked search results 347. Note that although ODP category labels are used in one implementation, any reasonable label source to tag queries and the URLs may be used. Further note that although the intent model is referred to as being the source of the re-ranking, it is permissible for this model to place zero weight on the current query. This effectively means that only the context model is used for re-ranking purposes. Alternatively, zero weight could be placed on the context (e.g., if multi-tasking is detected, leading to a noisy context signal), meaning that all weight is placed on the query.

In one implementation of re-ranking, a weight wᵢ is assigned to each result at rank position i in the top N search results (the “re-ranking candidates”), such as based on the following formula:

wᵢ=RankSigmoidᵢ(cosine(L_{M},L_{U}),N)·Posᵢ (3)

where L_{M} is the distribution of ODP category labels over the model, L_{U} is the distribution of ODP category labels for the current URL, cosine is the cosine similarity between the ODP category label distribution assigned to the current model (context, intent, and so forth) and the ODP category label distribution of the current URL, RankSigmoid is a weighting function depending on the similarity between the URL and the model being used for re-ranking and the URL rank, and Pos is a positional discount based on the position in the original ranked list, such that results with a lower-rank initially will receive a lower score. RankSigmoid and Pos can be defined as follows:

RankSigmoidᵢ=2/(1+(4·e^{-(1+c)})) (4)

where

c=cosine(L_{M},L_{U})·(N−i)

Posᵢ=1/(log(1+(i+1))/log(2)) (5)

There are various ways in which these weights and discounts can be constructed. For example, instead of cosine similarity, other measures of similarity such as Kullback-Liebler divergence and cross entropy may be used. The overall weight (wᵢ) for each search result in the top-N results is used to re-rank the results in descending order by wᵢ prior to presentation to the searcher, for example.

Thus, the search result re-ranker 346 presents the query 332 and the model received from the builder 340 to a search engine and re-ranks the search engine's results depending on the query, the intent model, and/or their relationship.

The re-ranked results may be returned to the user as is, or further processed by one or more additional re-ranking mechanisms for further re-ranking before returning the results to the user. That is, as represented in FIG. 3, the re-ranked results may be returned as is to the user, or alternatively, another re-ranking layer may use the re-ranked results as a starting point for further re-ranking based on one or more other criteria, or as may use the re-ranked results (or corresponding weight data) as suggestions for further re-ranking processing, such as in conjunction with the original data associated with the original search results 344.

In another alternative, the intent model may be fed into the search engine, such as other features used in initially ranking the results. Still further, the features of the context and query extracted from historic session logs may be used to train a machine learning algorithm to generate the original result ranking for the query based on context features, removing or reducing the need for re-ranking.

In determining whether and how to perform the result re-ranking, a number of factors can be considered, including query attributes and the degree of match between the query and the context. Note that this may be performed by the search result re-ranker 346, or a higher layer 348. For example, if the query has been found to have a navigational intent with a strong user preference toward a single URL placed first on the list (e.g., a query for [bing] will almost always lead to a click on the top-ranked result, www.bing.com), then the result re-ranker 346 or a higher layer 348 can be more conservative.

To build more accurate intent models, the models may be weighted/filtered based on the current query, such as to only include or up-weight labels from related actions in the context. Such related actions may be detected in various ways, including term overlap (e.g., between the current query and previous queries and/or titles/URLs/page-content), and/or by computing measures such as the cosine similarity between the query model and the models for each of the actions comprising the context. For example, a context for a vacation-related query may include vacation-related pages and queries, along with one social network site query and page where the user was briefly distracted; such an outlier query and page may be removed from or very lightly-weighted in the context. In cases where there are no related actions in the context, or if the maximum wᵢ does not exceed a threshold, then a decision may be taken (automatically) not to re-rank and instead present the user with the original result ranking.

One factor that may affect the relevance of any re-ranking is labeling associated with the top-ranked search results. In re-ranking, URLs with missing labels may end up at the bottom of the ranked list not because they are irrelevant, but because they cannot be labeled. One approach to avoid this issue is to use content (e.g., snippet) similarity as a way to propagate labels from pages without labels to those with labels, (where snippets are the short textual descriptions, often extracted from the page, that appear on the search engine result page below the title). Similarity of the document content and/or snippet also may be used where the confidence associated with a label is low.

Moreover, a URL may be classified at query time using document content (e.g., a snippet). This includes generating the category distributions for URLs and queries as needed (e.g., if missing), or reclassifying/revising any category distributions (e.g., such as when the confidence associated with a label is low).

For example, one online classification method may be used in which each URL is considered to have its own category distribution, each URL is represented as a linear combination of categories of other URLs, and coefficients of the linear combination are the cosine similarity between URLs' snippets. Snippets may be represented as a vector of snippet words constructed as term frequencies, and normalized. URLs with missing labels receive the labels of other URLs with which they have the most similar snippets. Note that a threshold on the minimum similarity between snippets and words of the query may be used, but in one implementation is not considered in similarity measurement as these words are mostly present in each snippet.

As can be readily appreciated, re-ranking is only one use of the intent model. Other possible uses include query classification and query suggestion, advertisement ranking/selection and task prediction.

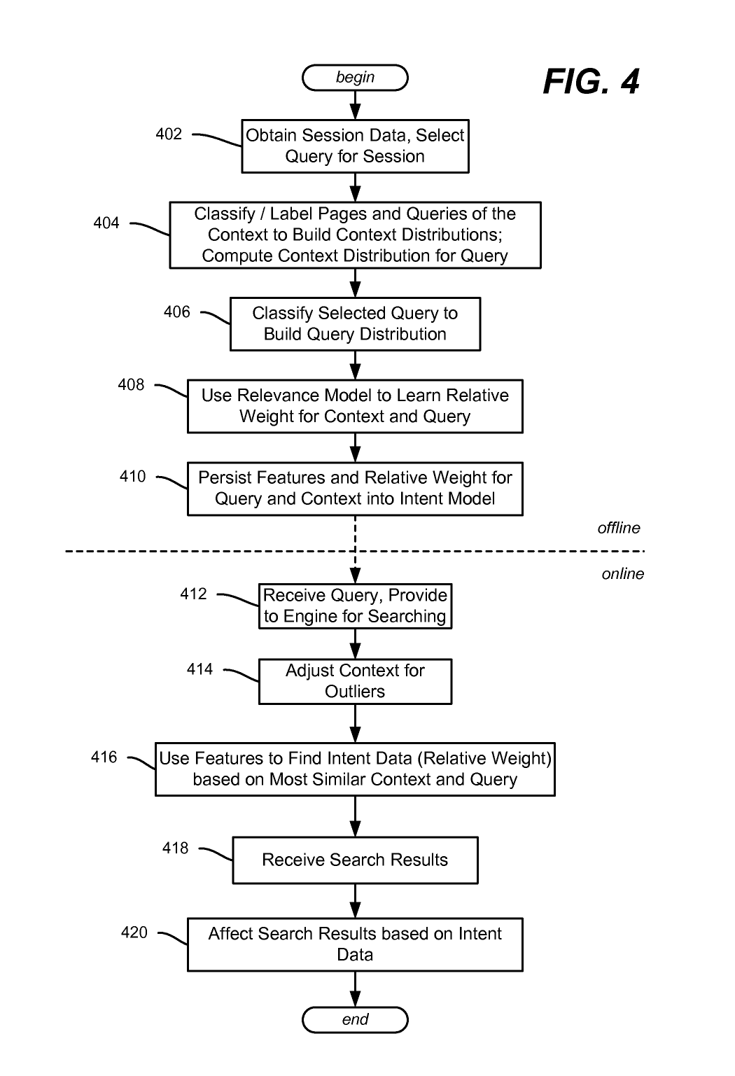

By way of summary, FIG. 4 is a flow diagram showing some example steps related to the above-described offline and online concepts. Step 402 represents obtaining the session data for a given session, and selecting a query for that session, e.g., one with prior context and post-click behavior.

Step 404 represents the classification of the prior context's pages and queries (based on their top returned pages) into the distributions, along with the merging of the distributions into a single context distribution as described above (e.g., weighted based on dwell time, discounted more based on age, and so forth). Step 406 represents the computation of the distribution for the selected query, e.g., based on the merged distributions of the top N pages returned for that query.

Step 408 represents the learning of the optimal relative weight for the context versus query based on the relevance model. Step 410 represents persisting the features of the query and context along with the relative weight into the intent model. These steps are repeated for other sessions/queries to build a more complete intent model.

Step 412 and forward represent the usage of the intent model in the online processing of a query. Step 412 represents receiving the query, and providing it to the search engine. Note that it is feasible to modify the query or otherwise change the search engine behavior based on the intent model, however the steps of FIG. 4 is only an example of one way to use the intent model, e.g., affecting the original search results in some way.

Step 414 represents the above-described (optional) step of filtering out or otherwise reducing the influence of “outlier” queries and/or pages in the context that do not appear to relate well to the rest of the context.

Step 416 is directed towards finding the intent data, including the relative weight and/or combined classification distribution, for this particular query and context. In general, step 416 feeds the features of the query and context into the intent model, with the intent data returned for the query and context with the most similar features that were previously learned in the model.

Once the search results are received (step 418) and the relative weight is known, the search results may be affected in some way (e.g., re-ranked) based on the context and query, and the relative weight. Step 420 represents this action, which may be ranking, re-ranking, selecting different advertisements, suggesting related queries for the results page, predicting the task the user is working on, and so forth.

### Exemplary Networked and Distributed Environments

One of ordinary skill in the art can appreciate that the various embodiments and methods described herein can be implemented in connection with any computer or other client or server device, which can be deployed as part of a computer network or in a distributed computing environment, and can be connected to any kind of data store or stores. In this regard, the various embodiments described herein can be implemented in any computer system or environment having any number of memory or storage units, and any number of applications and processes occurring across any number of storage units. This includes, but is not limited to, an environment with server computers and client computers deployed in a network environment or a distributed computing environment, having remote or local storage.

Distributed computing provides sharing of computer resources and services by communicative exchange among computing devices and systems. These resources and services include the exchange of information, cache storage and disk storage for objects, such as files. These resources and services also include the sharing of processing power across multiple processing units for load balancing, expansion of resources, specialization of processing, and the like. Distributed computing takes advantage of network connectivity, allowing clients to leverage their collective power to benefit the entire enterprise. In this regard, a variety of devices may have applications, objects or resources that may participate in the resource management mechanisms as described for various embodiments of the subject disclosure.

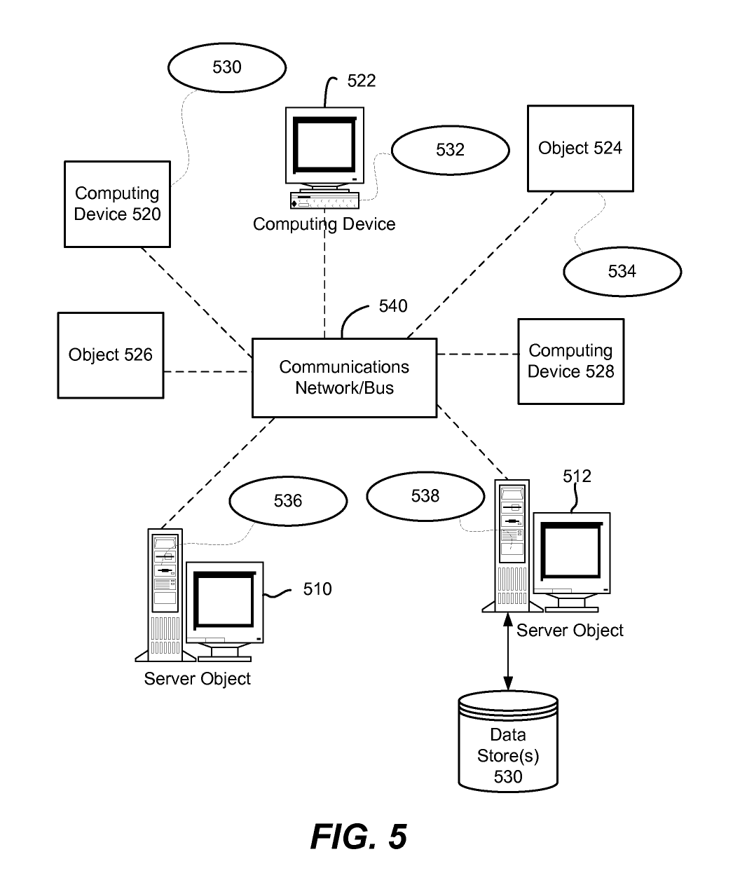

FIG. 5 provides a schematic diagram of an exemplary networked or distributed computing environment. The distributed computing environment comprises computing objects 510, 512, etc., and computing objects or devices 520, 522, 524, 526, 528, etc., which may include programs, methods, data stores, programmable logic, etc. as represented by example applications 530, 532, 534, 536, 538. It can be appreciated that computing objects 510, 512, etc. and computing objects or devices 520, 522, 524, 526, 528, etc. may comprise different devices, such as personal digital assistants (PDAs), audio/video devices, mobile phones, MP3 players, personal computers, laptops, etc.

Each computing object 510, 512, etc. and computing objects or devices 520, 522, 524, 526, 528, etc. can communicate with one or more other computing objects 510, 512, etc. and computing objects or devices 520, 522, 524, 526, 528, etc. by way of the communications network 540, either directly or indirectly. Even though illustrated as a single element in FIG. 5, communications network 540 may comprise other computing objects and computing devices that provide services to the system of FIG. 5, and/or may represent multiple interconnected networks, which are not shown. Each computing object 510, 512, etc. or computing object or device 520, 522, 524, 526, 528, etc. can also contain an application, such as applications 530, 532, 534, 536, 538, that might make use of an API, or other object, software, firmware and/or hardware, suitable for communication with or implementation of the application provided in accordance with various embodiments of the subject disclosure.

There are a variety of systems, components, and network configurations that support distributed computing environments. For example, computing systems can be connected together by wired or wireless systems, by local networks or widely distributed networks. Currently, many networks are coupled to the Internet, which provides an infrastructure for widely distributed computing and encompasses many different networks, though any network infrastructure can be used for exemplary communications made incident to the systems as described in various embodiments.

Thus, a host of network topologies and network infrastructures, such as client/server, peer-to-peer, or hybrid architectures, can be utilized. The “client” is a member of a class or group that uses the services of another class or group to which it is not related. A client can be a process, e.g., roughly a set of instructions or tasks, that requests a service provided by another program or process. The client process utilizes the requested service without having to “know” any working details about the other program or the service itself.

In a client/server architecture, particularly a networked system, a client is usually a computer that accesses shared network resources provided by another computer, e.g., a server. In the illustration of FIG. 5, as a non-limiting example, computing objects or devices 520, 522, 524, 526, 528, etc. can be thought of as clients and computing objects 510, 512, etc. can be thought of as servers where computing objects 510, 512, etc., acting as servers provide data services, such as receiving data from client computing objects or devices 520, 522, 524, 526, 528, etc., storing of data, processing of data, transmitting data to client computing objects or devices 520, 522, 524, 526, 528, etc., although any computer can be considered a client, a server, or both, depending on the circumstances.

A server is typically a remote computer system accessible over a remote or local network, such as the Internet or wireless network infrastructures. The client process may be active in a first computer system, and the server process may be active in a second computer system, communicating with one another over a communications medium, thus providing distributed functionality and allowing multiple clients to take advantage of the information-gathering capabilities of the server.

In a network environment in which the communications network 540 or bus is the Internet, for example, the computing objects 510, 512, etc. can be Web servers with which other computing objects or devices 520, 522, 524, 526, 528, etc. communicate via any of a number of known protocols, such as the hypertext transfer protocol (HTTP). Computing objects 510, 512, etc. acting as servers may also serve as clients, e.g., computing objects or devices 520, 522, 524, 526, 528, etc., as may be characteristic of a distributed computing environment.

### Exemplary Computing Device

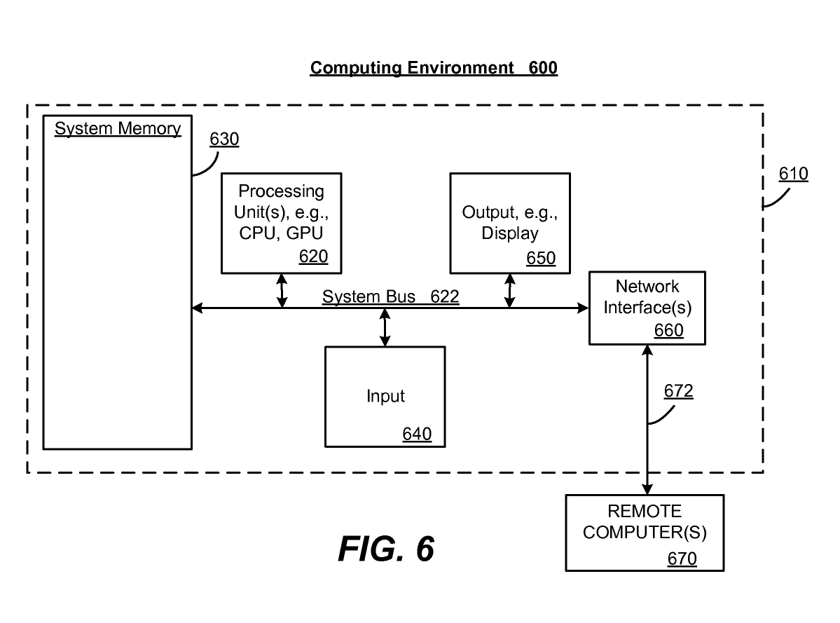

As mentioned, advantageously, the techniques described herein can be applied to any device. It can be understood, therefore, that handheld, portable and other computing devices and computing objects of all kinds are contemplated for use in connection with the various embodiments. Accordingly, the below general purpose remote computer described below in FIG. 6 is but one example of a computing device.

Embodiments can partly be implemented via an operating system, for use by a developer of services for a device or object, and/or included within application software that operates to perform one or more functional aspects of the various embodiments described herein. Software may be described in the general context of computer executable instructions, such as program modules, being executed by one or more computers, such as client workstations, servers or other devices. Those skilled in the art will appreciate that computer systems have a variety of configurations and protocols that can be used to communicate data, and thus, no particular configuration or protocol is considered limiting.

FIG. 6 thus illustrates an example of a suitable computing system environment 600 in which one or aspects of the embodiments described herein can be implemented, although as made clear above, the computing system environment 600 is only one example of a suitable computing environment and is not intended to suggest any limitation as to scope of use or functionality. In addition, the computing system environment 600 is not intended to be interpreted as having any dependency relating to any one or combination of components illustrated in the exemplary computing system environment 600.

With reference to FIG. 6, an exemplary remote device for implementing one or more embodiments includes a general purpose computing device in the form of a computer 610. Components of computer 610 may include, but are not limited to, a processing unit 620, a system memory 630, and a system bus 622 that couples various system components including the system memory to the processing unit 620.

Computer 610 typically includes a variety of computer readable media and can be any available media that can be accessed by computer 610. The system memory 630 may include computer storage media in the form of volatile and/or nonvolatile memory such as read only memory (ROM) and/or random access memory (RAM). By way of example, and not limitation, system memory 630 may also include an operating system, application programs, other program modules, and program data.

A user can enter commands and information into the computer 610 through input devices 640. A monitor or other type of display device is also connected to the system bus 622 via an interface, such as output interface 650. In addition to a monitor, computers can also include other peripheral output devices such as speakers and a printer, which may be connected through output interface 650.

The computer 610 may operate in a networked or distributed environment using logical connections to one or more other remote computers, such as remote computer 670. The remote computer 670 may be a personal computer, a server, a router, a network PC, a peer device or other common network node, or any other remote media consumption or transmission device, and may include any or all of the elements described above relative to the computer 610. The logical connections depicted in FIG. 6 include a network 672, such local area network (LAN) or a wide area network (WAN), but may also include other networks/buses. Such networking environments are commonplace in homes, offices, enterprise-wide computer networks, intranets and the Internet.

As mentioned above, while exemplary embodiments have been described in connection with various computing devices and network architectures, the underlying concepts may be applied to any network system and any computing device or system in which it is desirable to improve efficiency of resource usage.

Also, there are multiple ways to implement the same or similar functionality, e.g., an appropriate API, tool kit, driver code, operating system, control, standalone or downloadable software object, etc. which enables applications and services to take advantage of the techniques provided herein. Thus, embodiments herein are contemplated from the standpoint of an API (or other software object), as well as from a software or hardware object that implements one or more embodiments as described herein. Thus, various embodiments described herein can have aspects that are wholly in hardware, partly in hardware and partly in software, as well as in software.

The word “exemplary” is used herein to mean serving as an example, instance, or illustration. For the avoidance of doubt, the subject matter disclosed herein is not limited by such examples. In addition, any aspect or design described herein as “exemplary” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used, for the avoidance of doubt, such terms are intended to be inclusive in a manner similar to the term “comprising” as an open transition word without precluding any additional or other elements when employed in a claim.

As mentioned, the various techniques described herein may be implemented in connection with hardware or software or, where appropriate, with a combination of both. As used herein, the terms “component,” “module,” “system” and the like are likewise intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on computer and the computer can be a component. One or more components may reside within a process and/or thread of execution and a component may be localized on one computer and/or distributed between two or more computers.

The aforementioned systems have been described with respect to interaction between several components. It can be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it can be noted that one or more components may be combined into a single component providing aggregate functionality or divided into several separate sub-components, and that any one or more middle layers, such as a management layer, may be provided to communicatively couple to such sub-components in order to provide integrated functionality. Any components described herein may also interact with one or more other components not specifically described herein but generally known by those of skill in the art.

In view of the exemplary systems described herein, methodologies that may be implemented in accordance with the described subject matter can also be appreciated with reference to the flowcharts of the various figures. While for purposes of simplicity of explanation, the methodologies are shown and described as a series of blocks, it is to be understood and appreciated that the various embodiments are not limited by the order of the blocks, as some blocks may occur in different orders and/or concurrently with other blocks from what is depicted and described herein. Where non-sequential, or branched, flow is illustrated via flowchart, it can be appreciated that various other branches, flow paths, and orders of the blocks, may be implemented which achieve the same or a similar result. Moreover, some illustrated blocks are optional in implementing the methodologies described hereinafter.

### CONCLUSION

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

In addition to the various embodiments described herein, it is to be understood that other similar embodiments can be used or modifications and additions can be made to the described embodiment(s) for performing the same or equivalent function of the corresponding embodiment(s) without deviating therefrom. Still further, multiple processing chips or multiple devices can share the performance of one or more functions described herein, and similarly, storage can be effected across a plurality of devices. Accordingly, the invention is not to be limited to any single embodiment, but rather is to be construed in breadth, spirit and scope in accordance with the appended claims.

What is claimed is:

1. In a computing environment, a method performed at least in part on at least one processor, comprising:
receiving a search query;
obtaining context information corresponding to a context comprising one or more search-related activities that occurred prior to the search query; and
using features of the search query and features of the context information to obtain intent data from an intent model.

2. The method of claim 1 further comprising, using the intent data to rank or re-rank search results.

3. The method of claim 2 further comprising, using metadata associated with the search results to re-rank or further re-rank the search results.

4. The method of claim 2 wherein the search results include a URL, and further comprising, associating a label with the URL based on similarity of content with a labeled URL, or classifying a representation of the URL based upon content to generate a label.

5. The method of claim 1 wherein obtaining the context information comprises filtering or reducing influence of one or more of the search-related activities from the context.

6. The method of claim 1 further comprising, using the intent data to select one or more advertisement for inclusion with the search results.

7. The method of claim 1 further comprising, using the intent data to predict a task.

8. The method of claim 1 further comprising, using the intent data for query classification or query suggestion.

9. The method of claim 1 further comprising, modeling user search interests using the logged search-related data into one or more query models and one or more context models based upon pre-query activity, and combining the one or more query models and one or more context models into the intent model.

10. The method of claim 9 wherein the intent data corresponds to a combination of query information and context information, and further comprising, using a relevance model to compute an optimal combination of the query information and context information.

11. The method of claim 10 wherein using the relevance model comprises automatically determining the optimal combination across a plurality of queries, or on a per-query basis.

12. In a computing environment, a system comprising:
an intent model, the intent model comprising query features and context features, and further comprising data corresponding to an optimal combination of query information and context information learned from logged search-related activity data; and
a search engine component, the search engine component configured to extract features from a current query and a context of the current query, to access the intent model based upon the features to obtain intent data corresponding to an combination of query information and context information based on feature similarity with the extracted features, and to use the intent data to affect search results returned in response to the current search query.

13. The system of claim 12 wherein the search engine component comprises a search engine that uses the intent data to affect a ranking of search results returned in response to the query.

14. The system of claim 12 wherein the search engine component comprises a search result re-ranker that uses the intent data to affect a re-ranking of search results returned from a search engine in response to the query.

15. The system of claim 12 wherein the search engine component comprises an advertisement selection mechanism that uses the intent data to rank or re-rank advertisements returned in the search results in response to the query.

16. The system of claim 12 further comprising, means for dynamically adapting a search interface based on the intent data.

17. One or more computer-readable media having computer-executable instructions, which when executed perform steps, comprising:
modeling user search interests using interaction behavior into one or more query models, and one or more context models based upon logged search-related data including a query and associated context information representing pre-query activity;
combining the one or more query models and one or more context models into an intent model; and
using the intent model to perform a query-related task.

18. The one or more computer-readable media of claim 17 wherein combining the one or more query models and one or more context models into the intent model comprises learning an optimum combination based upon future actions or explicit relevance actions, or both, associated with the query information and the context information.

19. The one or more computer-readable media of claim 17 having computer-executable instructions comprising, classifying the query based on its corresponding returned search result pages into a query category distribution associated with the query information, and classifying the pre-query activity based on one or more pages or queries corresponding to that activity into a context category distribution associated with the context information.

20. The one or more computer-readable media of claim 17 wherein using the intent model to perform a query-related task comprises ranking or re-ranking search results.
